(19) United States
(12) Patent Application Publication
(10) Pub. No.: US 2010/0154962 A1
(43) Pub. Date: Jun. 24, 2010

(54) PNEUMATIC TIRE

(76) Inventors: Jean-Michel Alphonse Fernand Gillard, Arlon (BE); Roland Willibrord Krier, BIWER (LU)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 12/564,380

(22) Filed: Sep. 22, 2009

Related U.S. Application Data
(60) Provisional application No. 61/139,176, filed on Dec. 19, 2008.

(51) Int. Cl. B60C 9/00

(52) U.S. Cl. 152/532

(57) ABSTRACT

A pneumatic tire has a carcass and a belt reinforcing structure. The belt reinforcing structure includes a sine wave belt layer having a first and second axially outer edge, wherein the belt is laid up in a sine wave pattern which extends from a first edge to a second edge. Preferably the belt is laid up in strips of reinforced rubber having two or more cords, wherein the reinforcement cords are made of a high elongation cable.

This application claims the benefit of, and incorporates by reference, U.S. Provisional Application No. 61/139,176 filed Dec. 19, 2008.

### FIELD OF THE INVENTION

This invention relates to a pneumatic tire having a carcass and a belt reinforcing structure, and, more particularly, to radial ply tires for use in aircraft, trucks and other high load applications.

### BACKGROUND OF THE INVENTION

In tires that have heavy loads such as truck tires or aircraft tires, zigzag belt layers have been utilized for the belt package. An exemplary portion of a tire with a zigzag belt layer 5 is shown in FIG. 1. The advantage of zigzag belt layers is that the belt edges are folded at the edges near the shoulder, which greatly improves tire durability. The disadvantage to zigzag belt layers is that at the edges near the shoulder, there may be too many overlapping layers. In some areas there may be for example, 4 or more layers, and even 6 or more layers in some locations. The reduction of overlapping strips in the shoulder area should help improve durability. Thus it is desired to have a tire with improved belt edge durability without excess weight.

### SUMMARY OF THE INVENTION

In accordance with one example embodiment of the present invention, a pneumatic tire has a carcass and a belt reinforcing structure. The belt reinforcing structure includes a wavy belt layer having a first and second axially outer edge. The belt layer is formed of a strip of rubber shaped in a sine wave pattern extending from a first belt edge to a second belt edge. The belt structure may further include a circumferential belt layer formed of cords angled at 10 degrees of less relative to the circumferential direction.

In accordance with a second embodiment of the present invention, a pneumatic tire has a carcass and a belt reinforcing structure. The belt reinforcing structure includes a wavy belt layer having a first and second axially outer edge. The belt layer is formed of a strip of rubber shaped in a sine wave pattern extending from a first belt edge to a second belt edge. Wherein the strip of rubber has two or more cords, wherein the cords are made cable having an elongation at break of 4% or more.

### DEFINITIONS

“Apex” means a non-reinforced elastomer positioned radially above a bead core.

“Aspect ratio” of the tire means the ratio of its section height (SH) to its section width (SW) multiplied by 100% for expression as a percentage.

“Axial” and “axially” mean lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Cut belt” or “cut breaker reinforcing structure” means at least two cut layers of plies of parallel cords, woven or unwoven, underlying the tread, unanchored to the bead, and having both left and right cord angles in the range from 10 degrees to 33 degrees with respect to the equatorial plane of the tire.

“Bias ply tire” means a tire having a carcass with reinforcing cords in the carcass ply extending diagonally across the tire from bead core to bead core at about a 25-50 degree angle with respect to the equatorial plane of the tire. Cords run at opposite angles in alternate layers.

“Carcass” means the tire structure apart from the belt structure, tread, undertread, and sidewall rubber over the plies, but including the beads.

“Circumferential” means lines or directions extending along the perimeter of the surface of the annular tread perpendicular to the axial direction.

“Chafers” refer to narrow strips of material placed around the outside of the bead to protect cord plies from the rim, distribute flexing above the rim, and to seal the tire.

“Chippers” mean a reinforcement structure located in the bead portion of the tire.

“Cord” means one of the reinforcement strands of which the plies in the tire are comprised.

“Equatorial plane (EP)” means the plane perpendicular to the tire's axis of rotation and passing through the center of its tread.

“Flipper” means a reinforced fabric wrapped about the bead core and apex.

“Footprint” means the contact patch or area of contact of the tire tread with a flat surface at zero speed and under normal load and pressure

“Innerliner” means the layer or layers of elastomer or other material that form the inside surface of a tubeless tire and that contain the inflating fluid within the tire.

“Net-to-gross ratio” means the ratio of the tire tread rubber that makes contact with the road surface while in the footprint, divided by the area of the tread in the footprint, including non-contacting portions such as grooves.

“Nominal rim diameter” means the average diameter of the rim flange at the location where the bead portion of the tire seats.

“Normal inflation pressure” refers to the specific design inflation pressure and load assigned by the appropriate standards organization for the service condition for the tire.

“Normal load” refers to the specific design inflation pressure and load assigned by the appropriate standards organization for the service condition for the tire.

“Ply” means a continuous layer of rubber-coated parallel cords.

“Radial” and “radially” mean directions radially toward or away from the axis of rotation of the tire.

“Radial-ply tire” means a belted or circumferentially-restricted pneumatic tire in which the ply cords which extend from bead to bead are laid at cord angles between 65-90 degrees with respect to the equatorial plane of the tire.

“Section height” (SH) means the radial distance from the nominal rim diameter to the outer diameter of the tire at its equatorial plane.

“Sine wave or wavy belt reinforcing structure” means at least two layers of cords or a strip of parallel cords having 2 to 20 cords in each strip and laid up in a sine wave pattern between the lateral edges of the belt layer.

### BRIEF DESCRIPTION OF THE DRAWINGS

FIG. 1 is a schematic sectional view of part of a prior art tire having a zigzag belt;

FIG. 2 illustrates a partial cross-section of an exemplary radial tire 10 of the present invention;

FIG. 3 is an example of a tire building drum laid out circumferentially for illustration purposes illustrating the cord pattern of a wavy belt;

FIG. 4 illustrates the wavy belt of FIG. 3 in a finished state.

FIG. 5 illustrates the wavy belt being laid up on a tire building drum.

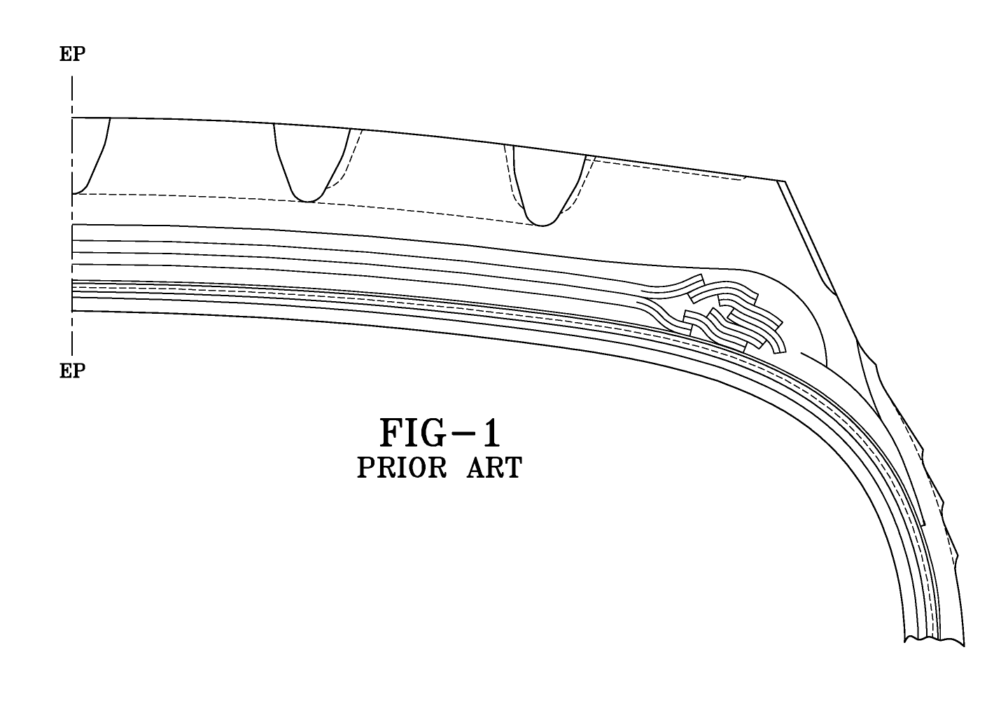

### DETAILED DESCRIPTION OF AN EXAMPLE EMBODIMENT THE INVENTION

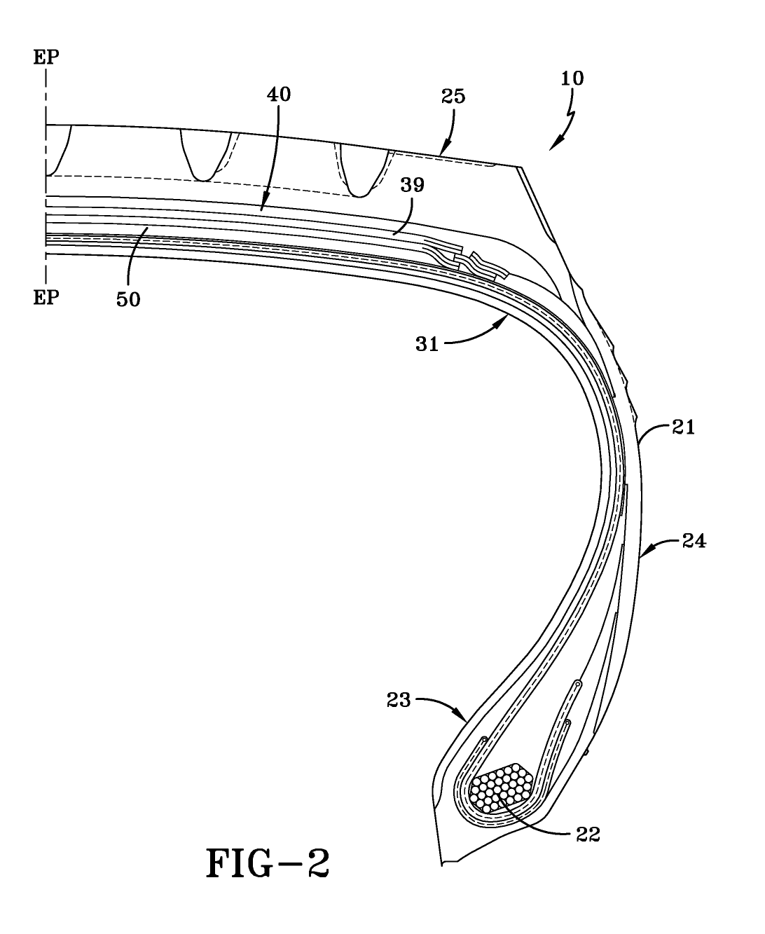

FIG. 2 illustrates a partial cross-section of an exemplary radial tire 10 which includes a bead portion 23 having a bead core 22 embedded therein, a sidewall portion 24 extending radially outward from the bead portion 23, and a cylindrical tread portion 25 extending between radially outer ends of the sidewall portions 24. The tire 10 is reinforced by a carcass 31 toroidally extending from one bead portion 23 to the other bead portion 23 (not shown). The carcass 31 may include at least one carcass ply 32. The carcass ply 32 is anchored to the bead core and for example, may wrap around each bead core 22 forming turnup portions. A belt structure 40 is arranged between the carcass 31 and the tread portion 25. The belt structure 40, according to an example embodiment of the present invention, comprises one or more belts, wherein at least one belt is a wavy belt structure 39.

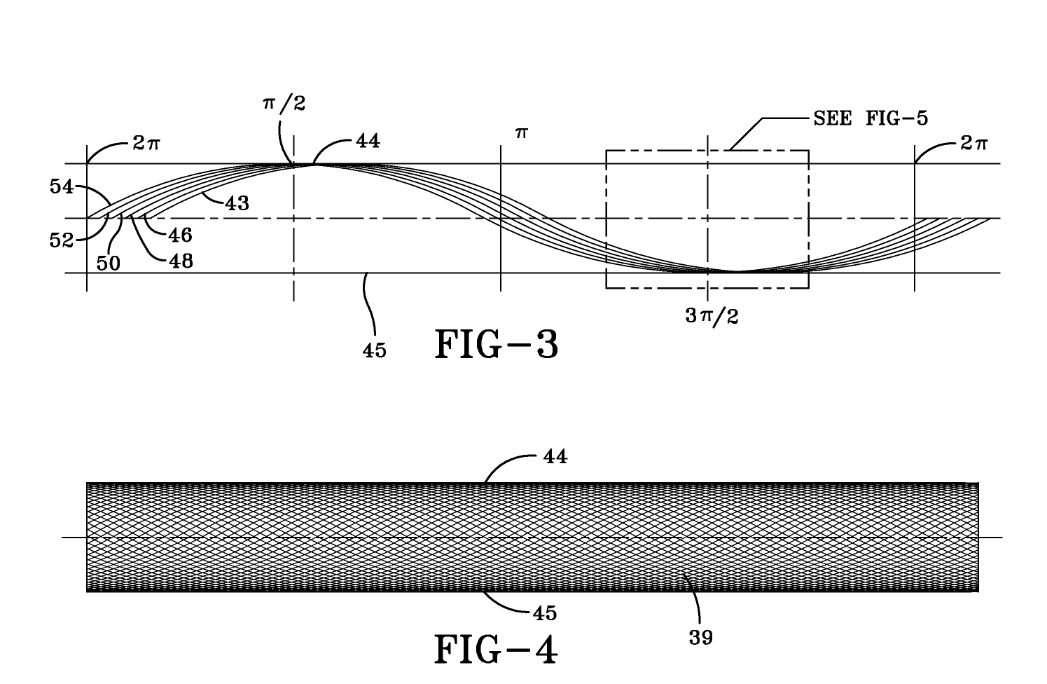

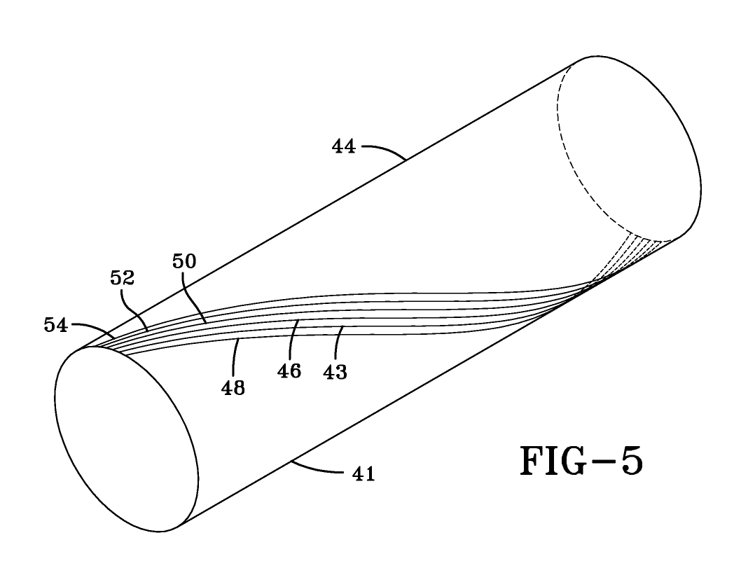

FIG. 3 illustrates the tire building drum wherein the outer circumference of the drum has been laid out in a planar fashion. As shown in FIG. 3, a first strip 43 of cords is laid up on the drum in a sine wave pattern. The strip is may range in size, but is typically half an inch in width and formed of a rubberized ribbon of two or more cords. The cord reinforcements may be formed of nylon, polyester or steel. For example, the strip reinforcements may comprise steel wires having a 3×7×.22 construction. Alternatively, the cords may comprise aramid. Alternatively, the cords may comprise high elongation wire. High elongation wire means having a % elongation at breaking force of at least 3.5%, preferably 4%. The measurements are taken from cords dipped in a RFL adhesive. Such dipping is well known to the man skilled in the art and has as main object to improve adherence of the cords to the rubbery material.

In this example, one sine wave is formed on one full drum rotation (2 pi radians). The sine wave may also be laid up on the drum in the range of ½ to about 2 waves per drum circumference (not shown). In this example the first wavy layer 43 is initially applied to the axial center of the drum, and is extended in a primarily circumferential direction in the shape of a continuous sine wave from the axially outer edge 44 of the drum to the opposite axial edge 45. The wavy layer has a sine wave shape. The period of the wave shape may vary from 0.5 to about 2 drum circumferences, and is preferably about 1. The period or circumferential length of the sine wave may be selected so that two adjacent strips do not overlap each other after one drum revolution. The amplitude of the wave may also vary. For Example, the amplitude may vary from about 0.25 to about 0.5 of a drum axial width.

As further shown in FIG. 3, additional strips 46, 48, 50, 52, 54 of cord are applied to the drum, also starting in the center (or other desired starting point). The strips 46, 48, 50, 52, 54 are initiated at sequential circumferential locations on the same centerline, i.e., indexed circumferentially. The sequential indexing of the strips results in less shoulder buildup of the strips. FIG. 4 illustrates a completed sine wave belt layer formed of a plurality of strips laid up in a sine wave pattern. The complete sine wave belt structure results in two layers of cords which are interwoven together and thus are inseparable.

In one example embodiment as shown in FIG. 2, the tire may comprise at least one sine wave belt structure 39, forming two layers of cord. Preferably, the tire comprises a circumferential belt layer 50 having an angle less then 10 degrees from the circumferential direction. Preferably the circumferential belt layer is spirally wound. The width of the circumferential belt layer is preferably less than the sine wave belt layer. The circumferential belt may be located radially inward or radially outward of the wavy belt structure 39. The exemplary tire may also comprise two sine wave belt layers, and a circumferential belt layer preferably positioned therebetween.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A pneumatic tire having a carcass and a belt layer interposed between a tread and the carcass, the belt layer comprising:
a wavy belt layer having a first and second axially outer edge, and formed of a strip of rubber shaped in a sine wave pattern extending from the first edge to the second edge; and a circumferential belt layer formed of cords angled at 10 degrees of less relative to the circumferential direction.

2. A pneumatic tire having a carcass and a belt layer interposed between a tread and the carcass, the belt layer comprising:
a wavy belt layer having a first and second axially outer edge, and formed of a strip of rubber shaped in a sine wave pattern extending from the first edge to the second edge; wherein the strip of rubber has two or more cords, wherein the cords are made cable having an elongation at break of 4% or more.

3. The pneumatic tire of claim 1 further including a circumferential layer having a cord angle of less than 15 degrees with respect to the circumferential direction.

4. The pneumatic tire of claim 4 wherein the circumferential layer is spirally wound.
